(19) United States
(12) Patent Application Publication
(10) Pub. No.: US 2012/0159309 A1
(43) Pub. Date: Jun. 21, 2012

(54) PICTURE DISPLAY APPARATUS AND PICTURE DISPLAY METHOD

(76) Inventors: Akinori Komaki, Ome-shi (JP); Yoshifumi Takayama, Fuchu-shi (JP); Hidehito Izawa, Hanno-shi (JP); Toshihiro Morohoshi, Kawasaki-shi (JP)

(21) Appl. No.: 13/308,396

(22) Filed: Nov. 30, 2011

(30) Foreign Application Priority Data
Dec. 21, 2010 (JP) 2010-285164

(51) Int. Cl. G06F 17/00

(52) U.S. Cl. 715/234

(57) ABSTRACT

According to one embodiment, a picture display apparatus includes: a web page acquiring section configured to acquire a web page; a focus-display section configured to split the web page into a plurality of areas and configured to focus-display one of the split areas on a picture display section; and a navigation display section configured to display a navigation on the picture display section indicating where the focus-displayed split-area is located on the web page.

### CROSS REFERENCE TO RELATED APPLICATION(S)

The application is based upon and claims the benefit of priority from Japanese Patent Application No. 2010-285164 filed on Dec. 21, 2010, the entire contents of which are incorporated herein by reference.

### BACKGROUND

1. Field

Embodiments described herein relate to a picture display apparatus and a picture display method.

2. Description of the Related Art

Picture display apparatuses (televisions, TVs) installed with a web browser and having network functionality are becoming more common.

By employing such a picture display apparatus (television, TV), a user can, for example, enjoy browsing by downloading web pages through a network and displaying the web pages on a picture display section.

Generally user operation to view television programs on a picture display apparatus (television, TV) is performed with a remote controller.

Browsing of web pages is also generally performed on a picture display apparatus (television, TV) with a remote controller.

However, web pages include many links, with the number of links sometimes exceeding 100. In such cases, for example, a user sometimes needs to click over 100 times just to move from the top link in the web page through to the desired link below when a remote controller is employed. There is hence demand for improvements in ease-of-operation, such as when browsing web pages on a picture display apparatus (television, TV).

Since, for example, the viewing distance of a user from a picture display section tends to increase as the size of display screens increases in a picture display apparatus (television, TV) it becomes difficult to view web pages in full-screen display and so improvements are desired in ease-of-operation for web page browsing.

Sometimes with a picture display apparatus (television, TV) a single screen of a web page is set so as not to fit within the frame of the screen, or with the screen scrolled using page-skip keys, for example, however these approaches are not easy to use and improvements are desired in ease-of-operation for web page browsing.

Improvements are desired in ease-of-operation for web page browsing on a picture display apparatus (television, TV) using, for example, a remote controller.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a block diagram showing an example of a configuration of a picture display apparatus according to an exemplary embodiment;

FIG. 2 illustrates the external appearance of a picture display apparatus according to an exemplary embodiment;

FIG. 3 illustrates the external appearance of a remote controller employed with a picture display apparatus according to an exemplary embodiment;

FIG. 4 illustrates an example of a first-level split-area display screen in a web page displayed on a picture display apparatus according to an exemplary embodiment.

FIG. 5 illustrates a second-level split-area display screen of a web page displayed on a picture display apparatus according to an exemplary embodiment;

FIG. 6 is part of a flow chart for explaining an operation of a picture display apparatus of an exemplary embodiment; and

FIG. 7 is part of a flow chart for explaining an operation of a picture display apparatus of an exemplary embodiment.

### DETAILED DESCRIPTION

Explanation follows regarding exemplary embodiments, with reference to the drawings.

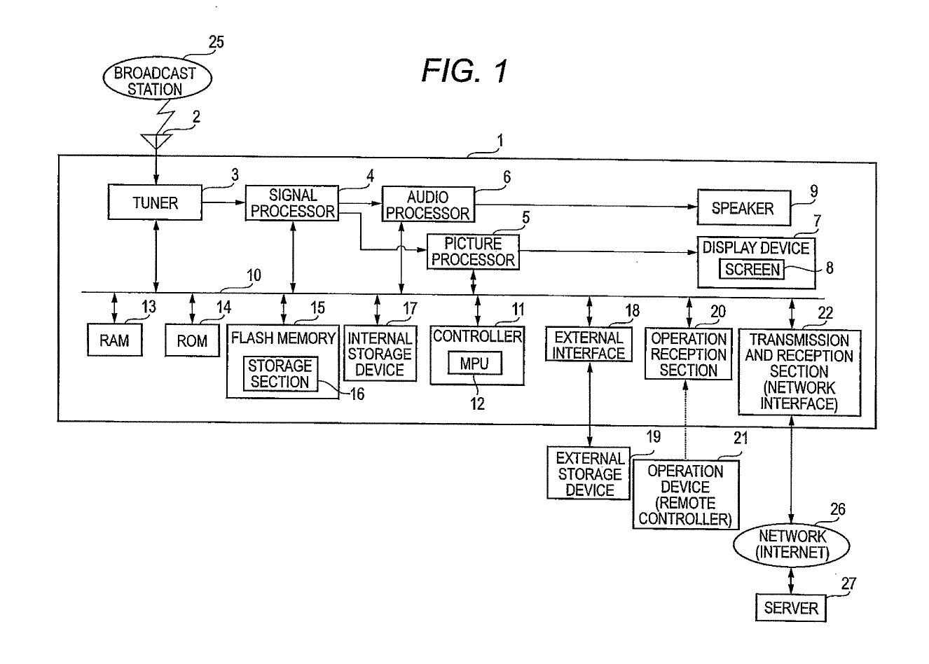

FIG. 1 is a block diagram illustrating an example of a configuration of a picture display apparatus (television) according to an exemplary embodiment.

A picture display apparatus (television) 1 is configured including an antenna 2, a tuner 3, a signal processor 4, a picture processor 5, an audio processor 6, a display device 7, a display screen (picture display section) 8, a speaker 9, a bus 10, a controller 11, an MPU 12, RAM 13, ROM 14, flash memory 15, a storage section 16, an internal storage device 17, and an external interface 18. A broadcast station 25 is also shown in FIG. 1.

The controller 11 is equipped with the MPU 12 and controls the picture display apparatus 1. The RAM 13, the ROM 14 and the flash memory 15 are utilized, for example, in processing performed by the controller 11.

The broadcast station 25 broadcasts picture contents by digital broadcast. The digital broadcast emitted from the broadcast station 25 is received by the tuner 3. Tuning is performed in the tuner 3 and then a digital signal of the picture contents is transmitted to the signal processor 4.

Signal processing is performed on the digital signal of the picture contents received by the signal processor 4, and a processed signal is then transmitted to the audio processor 6 and the picture processor 5.

The audio processor 6 receives the signal-processed picture contents, performs audio processing on the signal before then transmitting the signal to the speaker 9.

The speaker 9 receives the audio-processed signal and outputs sound.

The picture processor 5 receives the signal-processed picture contents, performs picture processing on the signal before then transmitting the signal to the display device 7. The display device 7 receives the picture-processed signal and displays the picture on the display screen (picture display section) 8 configured for example by an LCD panel.

The picture display apparatus (television) 1 in the present exemplary embodiment is equipped with the internal storage device 17 and has capability to record received picture contents.

The picture display apparatus (television) 1 in the present exemplary embodiment is also connected with a USB connection or a LAN connection to an external storage device 19. The picture display apparatus 1 has capability to record the received picture contents on the external storage device 19.

User operation of the picture display apparatus 1 is instructed, for example, by an operation device such as a remote controller 21.

The above processing is controlled by the controller 11.

The above picture display apparatus 1 is connected to a server 27 through a transmission and reception section (network interface) 22 to give capability to download (acquire) and browse web pages, for example.

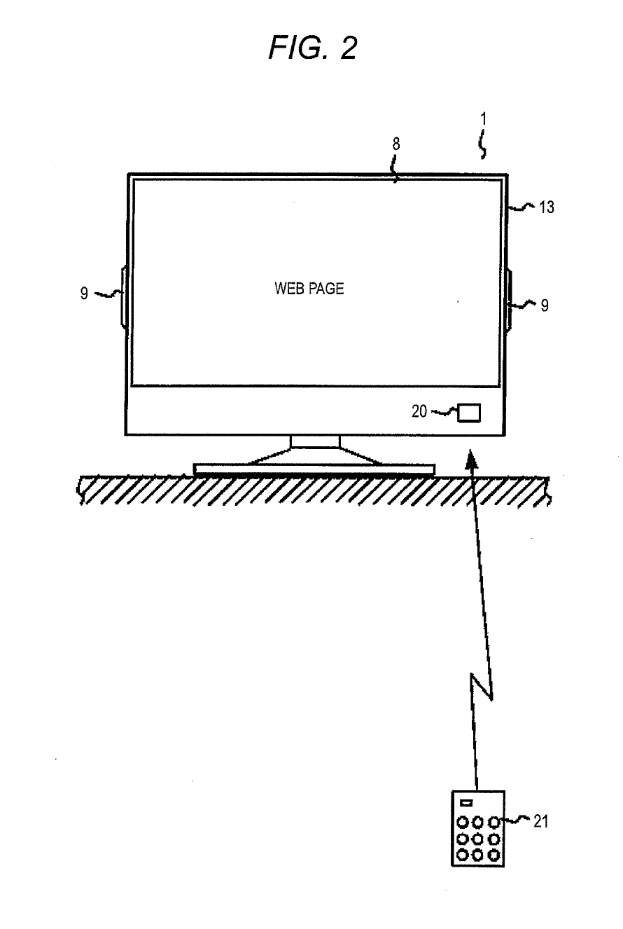

FIG. 2 illustrates the external appearance of a picture display apparatus according to an exemplary embodiment.

In the present exemplary embodiment, as described above, the picture display apparatus 1 is capable of downloading and browsing web pages through the transmission and reception section (network interface) 22.

The downloaded web pages are displayed on the display screen (picture display section) 8 of the picture display apparatus 1.

A user employs the remote controller 21 to operate web page browsing. A remote controller signal is output from the remote controller 21 and received by an operation reception section 20 of the picture display apparatus (television) 1.

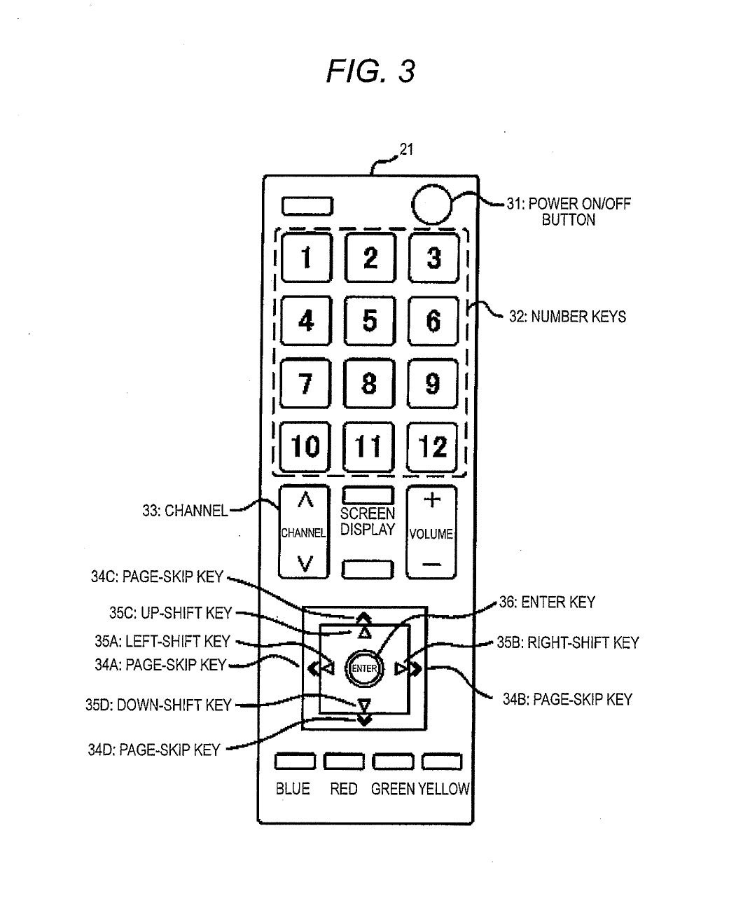

FIG. 3 illustrates the external appearance of a remote controller employed in a picture display apparatus according to an exemplary embodiment.

The remote controller 21 is equipped with a power button 31 and switching the power ON or OFF is controlled by user operation.

The remote controller 21 includes number keys 32 configured as a ten-key. The number keys 32 is used for web page browsing operations by a user, as described later.

The remote controller 21 also includes an up-down operation key for, for example, changing up or down the channel of the program being viewed.

Also included are: a left-shift key 35a for, for example, shifting a cursor displayed on the picture display section 8 by one shift to the left; a right-shift key 35b for shifting the cursor one shift to the right; an up-shift key 35c for shifting the cursor one shift upwards; and a down-shift key 35d for shifting the cursor one shift downwards.

A left page-skip key 34a is provided for, for example, page-skip shifting the cursor displayed on the picture display section 8 to the left. The following similar keys are also provided: a right page-skip key 34b for page-skip shifting the cursor to the right; an up page-skip key 34c for page-skip shifting the cursor upwards; and a down page-skip key 34b for page-skip shifting the cursor downwards.

An enter key 36 is provided for, for example, a user to confirm a cursor-displayed operation.

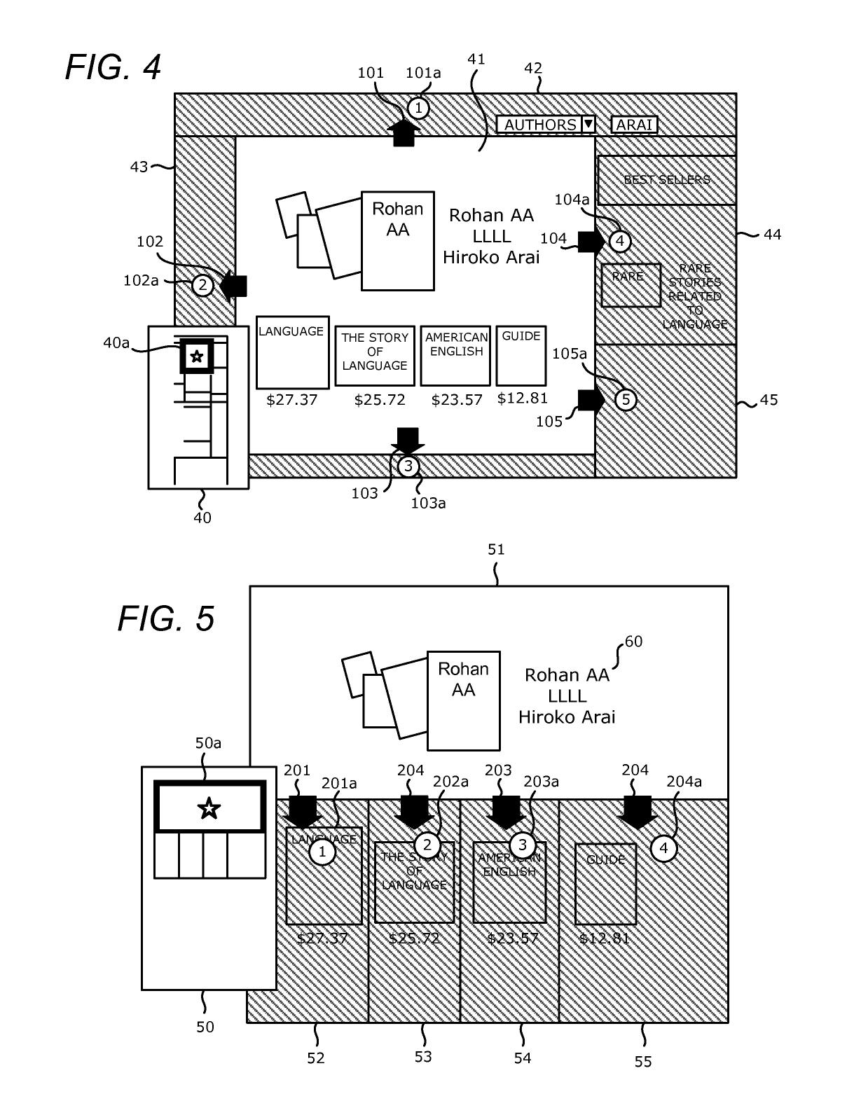

FIG. 4 illustrates an example of a first-level split-area display screen in a web page displayed on a picture display apparatus according to an exemplary embodiment.

Explanation follows regarding area splitting in a web page.

The exemplary embodiment is an example of area splitting in a web page enabling, for example, splitting into plural objects such that the number of links is as even as possible by computing link density from the tag structure of web contents (such as HTML and CSS).

A web page navigation display section 40 is shown. A focus-displayed split-area 40a is indicated.

Area 41 is the focus-displayed web page split-area itself.

Areas 42, 43, 44, and 45 are gray-out-displayed web page split-areas.

In the present exemplary embodiment the controller 11 of the picture display apparatus 1, for example, splits the downloaded web page into split-area (split-regions). When this is performed the focus-displayed web page split-area 41 is, for example, enlarged in display as much as possible to as to fit into the display screen of the picture display section 8.

Namely, positional adjustment and zoom processing is performed on the area including the focus-displayed web page split-area 41.

The focus-displayed web page split-area 41 is preferably, for example, a headline region at the top (upper portion) of the web page.

Namely, by applying focus to the headline region at the top (upper portion) of the web page, highlighted display is achieve so as to be readily understood by a user. Accordingly, split-areas other than the area in focus are each displayed grayed-out.

Gray-out-display is employed to direct the attention of a user to the split-area in focus, and is accomplished, for example, by gray displaying of buttons and portions for selection in those areas of the window.

In the present exemplary embodiment a navigation window indicating the shape of partitioning of the web page (browser) overall, namely the web page navigation display section 40, is shown together with the actual web page displayed on the picture display section 8.

The focus-displayed split-area 40a is shown in the window web page navigation display section 40. The location of the focus-displayed split-area 40a in the web page of the focus-displayed web page split-area 41 is indicated, for example.

A user can look at the web page navigation display section 40 and the location of the focus-displayed split-area 40a, and can thereby confirm where the focus-displayed web page split-area 41 is located on the web page.

Arrow 101 indicates a possible shift to the split-area at the top of the web page, and a user operation guide indicator 101a is shown.

The user operation guide indicator 101a is associated with a user operation of the remote controller 21.

For example, the focus-displayed web page split-area shifts when a user operates the “1” of the number keys 32 shifts. In this example operation of the “1” of the number keys 32 focus-displays the gray-out-displayed web page split-area 42 located above the currently focus-displayed web page split-area 41, and gray-out-displays the currently focus-displayed web page split-area 41.

Coupled to this operation, the location of the focus-displayed split-area 40a in the web page navigation display section 40 shifts upwards to indicate the location of the split-area 42.

Arrow 102 indicates a possible shift to the split-area on the left, and a user operation guide indicator 102a is shown.

Similarly to in the above, the focus-displayed web page split-area is shifted by user operation of the “2” of the number keys 32, for example. Operation of the “2” of the number keys 32 would hence focus-display the gray-out-displayed web page split-area 43 located to the left of the currently focus-displayed web page split-area 41.

Similarly, the location of the focus-displayed split-area 40a in the web page navigation display section 40 would also shift to the left, so as to indicate the location of the split-area 43.

Arrow 103 indicates a possible shift to the split-area at the bottom, and a user operation guide indicator 103a is shown. Arrow 104 indicates a possible shift to one of the split-areas at the right, and a user operation guide indicator 104a is shown. Arrow 105 indicates a possible shift to another of the split-areas at the right, and a user operation guide indicator 105a is shown.

Similarly, user operation of the number keys 32 (“3”, “4”, “5”) corresponding to the displayed guide indicators (103a, 104a, 105a) shifts the focus-displayed web page split-area and also shifts the location displayed on the web page navigation display section 40.

In the present exemplary embodiment, configuration may be made such that shifting between split-areas is by operation of the page-skip keys (34a, 34b, 34c, 34d), and shifting between finer links is performed with the up-down and left-right keys.

FIG. 5 illustrates a second-level split-area display screen of a web page displayed on a picture display apparatus according to an exemplary embodiment.

In the present exemplary embodiment, when a given focus-displayed split-area is selected (designated) from the first-level split-area display screen of a web page displayed on a picture display apparatus, the selected split-area is then, for example, split into plural objects such that the number of links is as even a possible by computing link density from the tag structure (such as HTML or CSS) of the web contents (second-level area splitting).

Selection of this split-area on the web page is performed, for example, by a user operating the enter key 36 of the remote controller 21 so as to select the focus-displayed split-area.

The selected web page split-area is second-level split to give a focus-displayed second-level split-area 51 of the web page.

Areas 52, 53, 54, 55 are gray-out-displayed web page split-areas.

In the present exemplary embodiment, the focus-displayed web page second-level split-area 51 is displayed enlarged by as much as possible to still fit within the display screen of the picture display section 8.

The focus-displayed web page second-level split-area 51 also preferably the headline region at the top (upper portion) of the split-area 41.

The focus-displayed web page second-level split-area 51 is also highlighted such that a user can readily ascertain that it is the split-area in focus. The second-level split-areas other than the second-level split-area in focus are hence respectively gray-out-displayed.

In the present exemplary embodiment there is also a web page second-level navigation display section 50 displayed together with the selected web page split-area.

A focus-displayed second-level split-area 50a is also similarly displayed in the second-level navigation display section 50. The focus-displayed second-level split-area 50a also indicates the location of the selected web page split-area.

A user can look at the second-level navigation display section 50 and the location of the focus-displayed second-level split-area 50a, and thereby confirm where the focus-displayed web page second-level split-area 51 currently displayed in focus is located.

Arrow 201 indicates a possible shift to the second-level split-area to a second-level split-area at the far-left bottom of the web page, and a user operation guide indicator 201a is shown.

The user operation guide indicator 201a is associated with a user operation of the remote controller 21.

For example, user operation of the “1” of the number keys 32 shifts the focus-displayed web page second-level split-area.

Accordingly, operation of the “1” of the number keys 32 focus-displays the gray-out-displayed web page second-level split-area 52 located below the currently focus-displayed web page second-level split-area 51 and gray-out-displays the currently focus-displayed web page second-level split-area 51.

Coupled to this operation, the location of the focus-displayed second-level split-area 50a in the second-level navigation display section 50 also shifts down to indicate the location of the split-area 52.

Similarly, the arrow 202 indicates a possible shift to the second-level split-area to another second-level split-area at the center-left bottom of the web page, and a user operation guide indicator 202a is shown.

For example, the focus-displayed web page second-level split-area is shifted when a user operates the “2” of the number keys 32. Accordingly, a gray-out-displayed web page second-level split-area 53 located below the currently focus-displayed web page second-level split-area 51 is focus-displayed in response to operation of the “2” of the number keys 32.

The location of the focus-displayed second-level split-area 50a in the second-level navigation display section 50 of the web page similarly shifts down to indicate the location of the split-area 53.

The arrow 203 indicates a possible shift of the second-level split-area to another second-level split-area at the center-right bottom of the web page, and a user operation guide indicator 203a is shown. The arrow 204 indicates a possible shift of the second-level split-area to another second-level split-area at the far-right bottom of the web page, and a user operation guide indicator 204a is shown.

The focus-displayed web page second-level split-area is shifted and the indicated location in the second-level navigation display section 50 is also shifted by similar user operation of the number keys 32 (“3”, “4”) corresponding to the guide indicators (203a, 204a).

A link display 60 is shown in FIG. 5.

The displayed link display is selected by user operation of the shift keys of the remote controller 21 (left-shift key 35a, right-shift key 35b, up-shift key 35c, down-shift key 35d) and the page-skip keys (left page-skip key 34a, right page-skip key 34b, up page-skip key 34c, down page-skip key 34d).

The controller 11 of the picture display apparatus (television) 1 controls link recording, downloads the web page to which the link is attached, and displays the web page on the picture display section 8.

The present exemplary embodiment accordingly manages a tree-configuration of areas with an embedded structure.

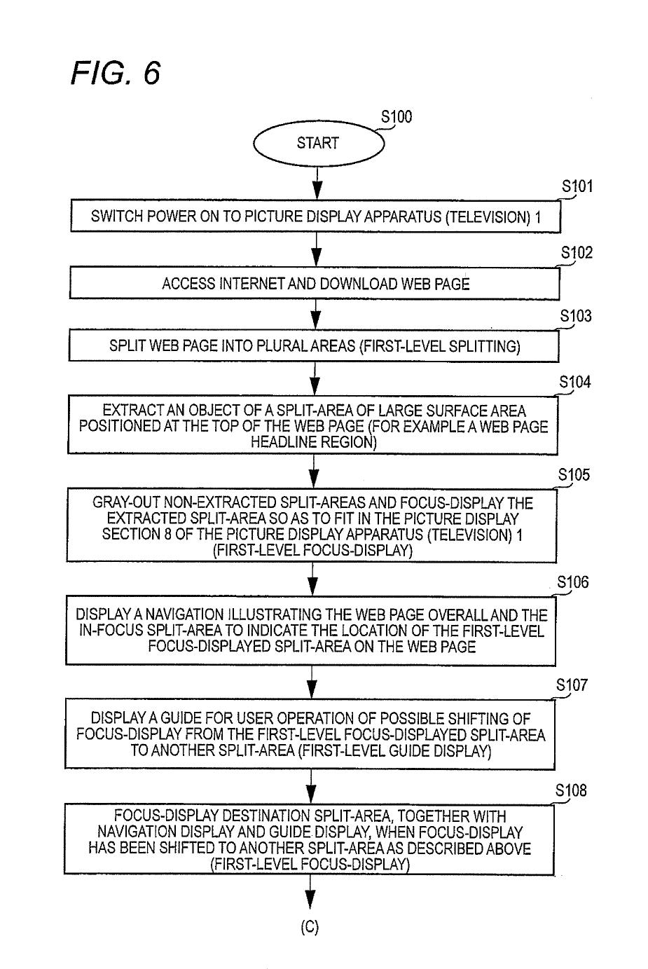

FIG. 6 is part of a flow chart for explaining an operation of a picture display apparatus of an exemplary embodiment.

Processing starts at step S100 then proceeds to step S101.

The power for the picture display apparatus (television) 1 is switched on at step 101. Processing then proceeds to step S102.

At step S102, the Internet is accessed and a web page is downloaded. Processing then proceeds to step S103.

At step S103, the downloaded web page is split into plural areas as described above (first-level splitting). Processing then proceeds to step S104.

At step 104 an object (such as a headline region of the web page) of a split-area of large surface at the top (upper portion) of the web page is extracted. Processing then proceeds to step S105.

At step 105, the non-extracted split-areas are grayed out and the extracted split-area is focus-displayed (first-level focus-display) such that the extracted split-area fits in the picture display section 8 of the picture display apparatus (television) 1. Processing then proceeds to step S106.

At step 106 a navigation is displayed of the web page as a whole and the focus-displayed split-area, so as to indicate the location of the first-level focus-displayed split-area on the web page (first-level navigation display). Processing then proceeds to step S107.

At step S107, user operation guide indicators are displayed to indicate a possible shift of focus-display from the first-level focus-displayed split-area to another split-area (first-level guide display). Processing then proceeds to step S108.

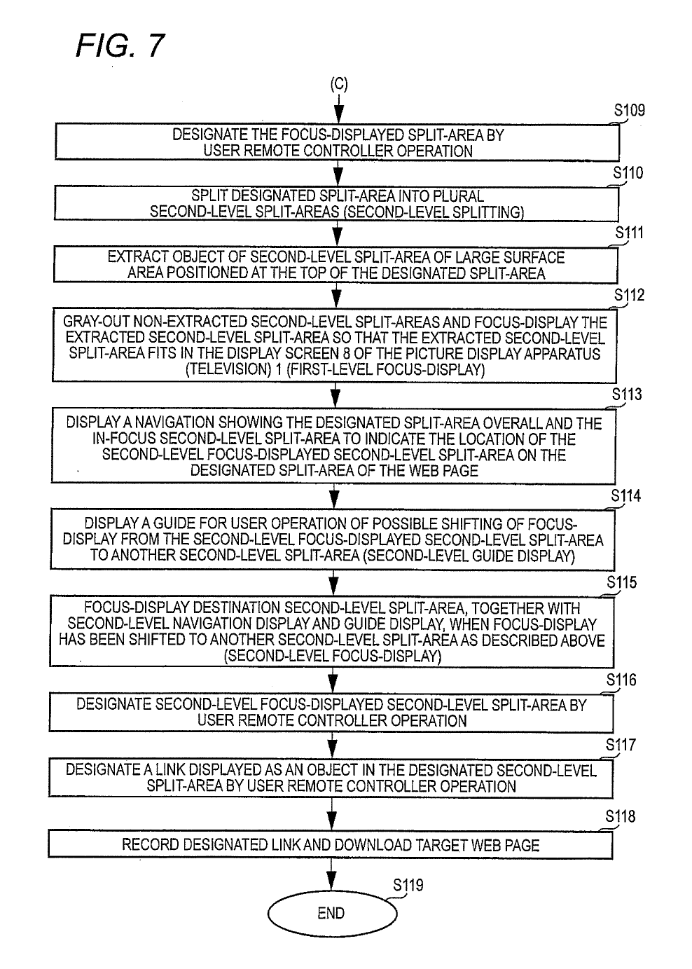

At step 108, when focus-display is shifted to another of the split-areas, the destination split-area is focus-displayed together with the navigation display and guide indicator (first-level focus-display). Processing then proceeds to step S109, as shown in FIG. 7.

FIG. 7 is part of a flow chart for explaining an operation of the picture display apparatus of an exemplary embodiment.

At step S109 a user designates the focus-displayed split-area by remote controller operation. Processing then proceeds to step S110.

At step S110 the designated split-area is split into plural second-level split-areas (second-level splitting). Processing then proceeds to step S111.

At step S111 an object is extracted of a second-level split-area of large surface area located at the top of the designated split-area. Processing then proceeds to step S111.

At step S112 the non-extracted second-level split-areas are grayed out and the extracted second-level split-area is focus-displayed (second-level focus-displayed) so that the extracted second-level split-area fits within the picture display section 8 of the picture display apparatus (television) 1. Processing then proceeds to step S113.

At step S113 a navigation is displayed of the designated split-area as a whole and the focus-displayed second-level split-area, so as to indicate the location of the second-level focus-displayed second-level split-area on the web page designated split-area (second-level navigation display). Processing then proceeds to step S114.

At step S114 user operation guide indicators are displayed to indicate possible shifts of focus-display from the second-level focus-displayed second-level split-area to another second-level split-area (second-level guide display). Processing then proceeds to step S115.

At step S115, for performing focus-display when focus-display has been shifted to another of the second-level split-areas, the destination second-level split-area is focus-displayed together with the second-level navigation display and second-level guide indicator (second-level focus-display). Processing then proceeds to step S116.

At step 116 a user designates the second-level focus-displayed second-level split-area by remote controller operation. Processing then proceeds to step S117.

At step S117 a user designates a displayed link to an object in the designated second-level split-area. Processing then proceeds to step S118.

At step S118 the designated link is recorded for downloading the target web page. Processing then proceeds to step S119.

Processing is ended at step S119.

The present exemplary embodiment configured as described above enables ease-of-operation to be enhanced for, for example, browsing web pages using a remote controller on a picture display apparatus (television).

While explanation in the above exemplary embodiment is of an example of focus-display so as to highlight the split-area in focus by gray-out-display of split-areas other than the split-area in focus, other configurations may be employed to place split-areas in focus and highlight the split-area in focus. Such configurations include displaying the split-area in focus in 3D (three dimensions) and displaying split-areas other than the split-area in focus in 2D (two dimensions).

Namely, in the present exemplary embodiment, web contents such as a web page is split into plural areas (regions), one of the split-areas is placed in focused, so as to be enlarged and displayed. Such a configuration enables viewing characteristics of a browser to be enhanced.

The split areas (regions) are allocated individual numbers, and a user can shift the split-area for focus-display by, for example, operation of the number keys 32 of a remote controller 21. Such a configuration facilitates browser operation and enables ease-of-use enhancements for a user.

Split-areas other than the split area (region) that is focus-displayed as described above are gray-out-displayed. Such a configuration enables improved readability of a browser by a user.

The overall partitioning of the browser is displayed on navigations (the navigation display sections 40, 50). Such a configuration enables viewing characteristics of a browser to be enhanced.

The headline region of the split-area web contents is placed in focus. Such a configuration enables browser ease-of-operation to be enhanced.

Splitting is performed, for example, by computing the link density from the web contents tag structure (such as HTML and CSS), and splitting the web contents into plural objects with as even a number of links as each other as possible, and with consideration to the location of links and images. Such a configuration enables contents splitting precision to be enhanced.

Aspects of the physical layout of the remote controller may also be assigned to the layout of the web page, such that the number keys 32 can be employed for operation. Such a configuration enables the ease-of-operation of a web browser to be enhanced.

The split-area in focus may, for example, be displayed in 3D. Such a configuration enables the readability of a browser to be raised.

The exemplary embodiments according to the above configurations enable ease-of-operation to be enhanced when performing browser operation, such as on a web page on a picture display apparatus (television) using a remote controller.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture display apparatus comprising:
a web page acquiring section configured to acquire a web page;
a focus-display section configured to split the web page into a plurality of areas and configured to focus-display one of the split areas on a picture display section; and
a navigation display section configured to display a navigation on the picture display section indicating where the focus-displayed split-area is located on the web page.

2. The picture display apparatus of claim 1, wherein
the split-area focus-display includes a web page headline.

3. The picture display apparatus of claim 1, wherein
split-area focus displaying includes graying out split-areas not focus-displayed.

4. The picture display apparatus of claim 1, further comprising
a guide display section configured to display on the picture display section a guide display indicating possible focus-display shifting from the focus-displayed split-area to another split-area.

5. The picture display apparatus of claim 1, wherein
the navigation display and the guide display, showing the other split-area, are displayed on the picture display section when focus displaying the other split-area.

6. The picture display apparatus of claim 1 further comprising
a display adjusting section configured to adjust display by performing positional adjustment and zoom processing so that the split-area for focus-display fits within the picture display section.

7. The picture display apparatus of claim 1 further comprising
a second-level focus-display section for splitting a designated split-area into a plurality of second-level split-areas when the focus-displayed split-area is designated, and displaying one of the split second-level split-areas on the picture display section.

8. The picture display apparatus of claim 1 wherein
a portion of the focus-displayed split-area is displayed in three dimensions.

9. A picture display apparatus comprising:
a web page acquiring section configured to acquire a web page;
a focus-display section configured to split the acquired web page into a plurality of areas and configured to focus-display a split areas for focus-display on a picture display section by gray-out-display of split-areas not focus-displayed; and
a guide display section configured to display on the picture display apparatus a guide display for user operation indicating possible focus-display shifting from the focus-displayed split-area to another split-area.

10. A picture display method comprising:
acquiring a web page;
splitting the acquired web page into a plurality of areas and focus-displaying one of the split areas on a picture display section;
displaying a navigation on the picture display section indicating where the focus-displayed split-area is located on the web page.
